(19) United States
(12) Patent Application Publication
(10) Pub. No.: US 2005/0080818 A1
(43) Pub. Date: Apr. 14, 2005

(54) Active images

(76) Inventors: Timothy P. Kindberg, Burlingame, CA (US); Rakhl S. Rajani, Sunnyvale, CA (US); Mirjana Spasojevic, Palo Alto, CA (US); Ella Tallyn, London (GB)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/683,975

(22) Filed: Oct. 10, 2003

(51) Int. Cl. G06F 7/00

(52) U.S. Cl. 707/104.1

(57) ABSTRACT

Technologies are disclosed for creating non-digital active images by associating specified regions, of a base image including non-digital content fixed in a tangible medium, with arbitrary digital content that can be electronically outputted upon later selection of any of the specified regions. Technologies are also disclosed for creating similar content-associated regions of a digital image, and for using the resulting digital active image, in a collaborative environment.

### CROSS-REFERENCE TO RELATED APPLICATION

This patent is related to pending U.S. patent application entitled “Conveying Access to Digital Content Using a Physical Token,” Ser. No. [S/N to be added by Amendment], filed on Oct. 10, 2003, which is hereby incorporated by reference in its entirety. As a matter of convenience, the foregoing shall be referred to herein as the “Related Application.”

### BACKGROUND

Visible content may be represented as images, either printed on tangible media or digitally displayed.

Some types of digitally displayable content, such as a HTML-based Web page, may include embedded hypertext links to other digital content. But many other types of digitally displayable content, such as personal digital photos, are not HTML-based. Thus, creating links within this type of digital content is more challenging. Some existing software allows Web page creators to add textual annotations (but not links) to non-HTML-based images. Other software allows the use of an image (e.g., a thumbnail or other portion of an image) as a link to another Web page. For example, in a Web page showing a map of the United States, clicking on an individual state might take the user to another Web page containing a map of individual cities in that state. However, current techniques for providing links within digital images are difficult to use. Thus, it is difficult to create images with links in substantially real time, for example, during a meeting.

In the case of images printed on tangible media (rather than a digital version), current ways to provide links to digital content, such as by printing URLs along with the images, are obstrusive.

Thus, a market exists for processes to allow one to readily provide links within (printed or digital) images to digital content.

### SUMMARY

An exemplary method for creating a non-digital active image, fixed in a tangible medium, at least one region of which may be selected by a user to access digital content on an electronic output device, comprises: obtaining a description of a base image (the base image including non-digital content fixed in a tangible medium), creating a database record for the base image associated with the description, receiving a descriptor of a region of the base image, receiving a representation of digital content, and associating the descriptor with the digital content in the database record, thereby creating an active image usable to electronically access the digital content from the base image of non-digital content fixed in the tangible medium.

An exemplary method for electronically outputting digital content accessed by selecting regions of a non-digital active image fixed in a tangible medium, comprises: receiving a descriptor of a region of an image (the image including non-digital content fixed in a tangible medium, and at least one predetermined region of the image that is associated with digital content via a database record in a computer system), obtaining the database record, resolving the descriptor to determine digital content associated therewith in the database record, and electronically obtaining and outputting, to the user, the determined digital content.

An exemplary method for creating an active image in a collaborative environment, at least one region of the active image may be selected by a user to access digital content on an electronic output device, comprises: obtaining a reference to a base image (the base image including images of participants and at least one shared object being used in a collaborative environment), receiving a participant-specified descriptor of a region of the base image, receiving a participant-specified representation of digital content, the digital content including an electronic copy of materials being presented in the collaborative environment via the at least one shared object, associating the descriptor with the digital content, and updating the base image including the association between the descriptor and the digital content, thereby creating an active image usable to electronically access the digital content from the base image.

Other embodiments and implementations are also described below.

### BRIEF DESCRIPTION OF THE FIGURES

FIG. 1 illustrates an exemplary operating environment for creating an active image, and accessing active regions of the active image.

FIG. 2 illustrates an exemplary process for creating a digital active image.

FIG. 3 illustrates an exemplary process for creating a non-digital active image.

FIG. 4 illustrates an exemplary process for accessing active regions within an active image.

FIG. 5 illustrates an exemplary process for accessing active regions within an active image using identifiers.

FIG. 6 illustrates an exemplary process for generating contextual identifiers for identifying active regions on an active image.

FIG. 7 illustrates an exemplary process for accessing active regions within an active image using contextual identifiers.

### DETAILED DESCRIPTION

I. Overview

Exemplary technologies for creating active images and accessing active regions within the active images are described herein. More specifically:

Section II describes an exemplary operating environment for various embodiments to be described herein;

Section III describes exemplary processes for creating an active image;

Section IV describes exemplary processes for accessing active regions within an active image; and

Section V describes exemplary processes for generating contextual identifiers and for using the contextual identifiers to access active regions on an active image.

II. An Exemplary Operating Environment for Creating an Active Image and Accessing Active Regions on an Active Image

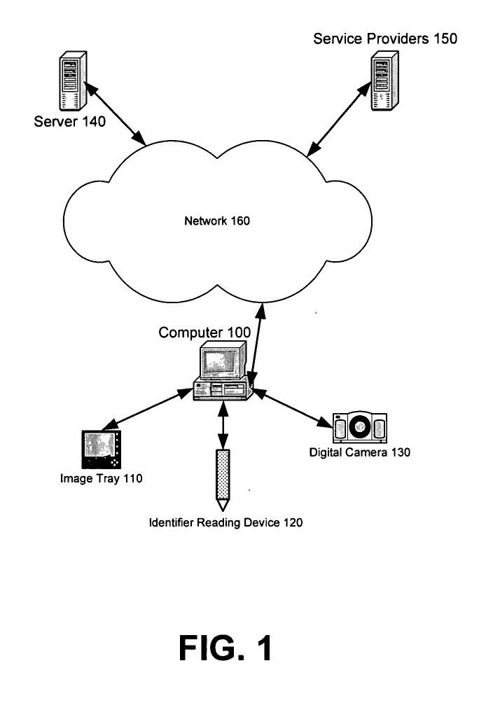

FIG. 1 is a block diagram of an exemplary operating environment. The description of FIG. 1 is intended to provide a brief, general description of one common type of computing environment in conjunction with which the various exemplary embodiments described herein may be implemented.

Of course, other types of operating environments may be used as well. For example, those skilled in the art will appreciate that other computer system configurations, including hand-held devices, multiprocessor systems, microprocessor-based or programmable consumer electronics, network PCs, minicomputers, mainframe computers, and the like may also be implemented.

Further, various embodiments described herein may also be practiced in distributed computing environments where tasks are performed by remote processing devices that are linked through a communications network. In a distributed computing environment, program modules may be located in both local and remote memory storage devices.

The exemplary operating environment of FIG. 1 includes a general purpose computing device in the form of a computer 100. The computer 100 may be a conventional desktop computer, laptop computer, handheld computer, distributed computer, tablet computer, or any other type of computing device.

The computer 100 may include a disk drive such as a hard disk (not shown), a removable magnetic disk, a removable optical disk (e.g., a CD ROM), and/or other disk and media types. The drive and its associated computer-readable media provide for storage of computer-readable instructions, data structures, program modules, and other instructions and/or data for the computer 100. It should be appreciated by those skilled in the art that any type of computer-readable media which can store data that is accessible by a computer, such as magnetic cassettes, flash memory cards, digital video disks, random access memories (RAMs), read only memories (ROMs), and the like, may also be used in the exemplary operating environment.

A number of program modules may be stored on the computer 100. Exemplary program modules include an operating system, one or more application programs, other program modules, and/or program data.

A user may enter commands and information into the computer 100 through input devices such as a keyboard, a mouse, and/or a pointing device. Other input devices could include an image tray 110, an identifier reading device (e.g., scanner) 120, and a digital camera 130, one or more of which may be used for creating or accessing active regions within active images. Exemplary implementations using these input devices will be described in more detail below.

A monitor or other type of display device may also be connected to computer 100. Alternatively, or in addition to the monitor, computer 100 may include other peripheral output devices (not shown), such as an audio system, projector, display (e.g., television), or printers, etc.

The computer 100 may operate in a networked environment using logical connections to one or more remote computers. The remote computers may be another computer, a server, a router, a network PC, a client, and/or a peer device, each of which may include some or all of the elements described above in relation to the computer 100.

In FIG. 1, the computer 100 is connected to server 140 and service provider 150 via a communication network 160. The communication network 160 could include a local-area network (LAN) and/or a wide-area network (WAN). Such networking environments are commonplace in offices, enterprise-wide computer networks, intranets and the Internet. The network configuration shown is merely exemplary, and other technologies for establishing communications links among the computers may also be used.

The embodiments described herein may be implemented in an operating environment comprising software installed on a computer, in hardware, or in a combination of software and hardware. Generally, the programmed logic may be implemented in any combination of hardware and/or software. In the case of software, the terms program, code, module, software, and other related terms as used herein may include routines, programs, objects, components, data structures, etc., that perform particular tasks or implement particular abstract data types.

III. Creating an Active Image

An image is “active” when it contains additional information (e.g., text, audio, video, Web page, other electronic resources, other digital media, links to electronic resources or digital media, links to Web-based services or operations, etc.) associated with the image that may be accessed from the image itself. For ease of explanation, the additional information will be referred to as “digital content” throughout this patent. In addition, various exemplary embodiments will be described by referring to images. Exemplary Web-based services or operations may include, without limitation, services which allow a user to control light switches by accessing a Web page provided by the services. See, for example, U.S. Pat. Nos. 6,160,359, 6,118,230, and 5,945,993, issued to Fleischmann and assigned to the assignee of this patent. These patents are hereby incorporated by reference for all purposes. In an exemplary implementation, the active image may include a link (e.g., URL) to a Web page provided by Web-based services or operations.

The images themselves may include, without limitation, pictures, text, and/or other forms of media that may be visually represented either digitally or in a tangible form. An active image may be digital or non-digital (e.g., printed or otherwise fixed on a tangible medium). Section III.A below describes an exemplary process for creating a digital active image and Section III.B below describes an exemplary process for creating a non-digital active image.

A. Creating a Digital Active Image

1. An Exemplary Process to Create a Digital Active Image

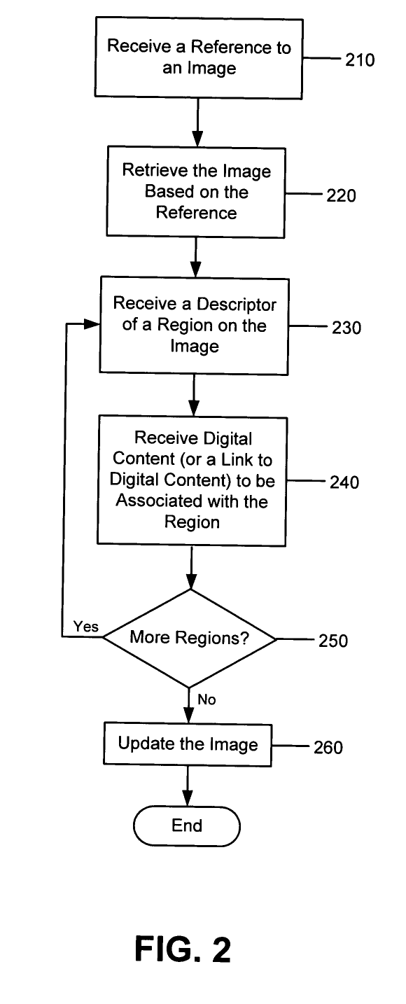

A digital active image may be created by associating digital content with one or more regions (for convenience, referred to as “active regions”) on a digital image (for convenience, referred to as a “base image”), thereby enabling the associated content to be accessed by clicking on the active region within the base image. FIG. 2 illustrates an exemplary process for creating a digital active image.

At step 210, a reference (e.g., an address) to a base image is received by the server 140. In an exemplary implementation, a Web page may be displayed to a user to allow the user to identify a base image. For example, the user may browse and select a file located in a local hard disk, or input a URL of an image at a remote server accessible via the network 160.

At step 220, the base image is retrieved based on the reference and displayed to the user. The user may now begin to associate digital content with the base image.

At step 230, a descriptor (e.g., a selection) of a region on the image is received from the user. For example, the user may use a mouse to drag and select a region on the image using software creation tools known in the art to represent the region as a polygon using the HMTL “map name” and “area shape” tags for defining a geometric (circular, rectangular, or polygonal) area within a map by reference to the coordinates of the area. One such commercially available tool is known as MapEdit, available as shareware from Boutell.com at http://www.boutell.com/mapedit/.

At step 240, a representation of digital content (e.g., an address to digital content) to be associated with the region is received from the user. In an exemplary implementation, the server 140 may provide blank fields to the user for user to input digital content (e.g., textual annotations, an image file, a sound clip, etc.) or an address to digital content (e.g., a URL). For example, the associated content can be inputted using the MapEdit shareware referenced above. In the case of a sound clip, the user may also have the option of recording the sound clip in real time. This implementation can be achieved by using digital audio recording technologies known in the art.

At step 250, whether the user wants to select another region on the baseline image is determined. In an exemplary implementation, the user is queried by the server 140. If another region is selected, the process repeats at step 230.

If the user does not wish to select another region, then at step 260, the baseline image is updated by the server 140 to include links to the associated content. In an exemplary implementation, a new version of the image is saved. Depending on design choice, each time a new region is selected and linked to digital content, either the original or the new version of the base image is updated.

The process steps illustrated above are merely exemplary. Those skilled in the art will appreciate that other steps and/or sequences may be used in accordance with the requirements of a particular implementation. For example, the digital content to be associated with a region on a base image (step 240) may be received prior to receiving a selection of a region on the base image (step 230), etc.

2. Exemplary Methods to Indicate Active Regions on an Image

Active regions on an active image can be identified by color, brightness, or other visual or audio enhancement techniques. For example, without limitation, the selected areas may remain visible on the image but be a fainter color than the rest of the image, the active (or inactive) region(s) on the image may be in focus, targets and/or other indicators/markers may be placed on the active regions, active regions may glow and/or have slightly different color than the inactive regions, “hot-cold” sounds may be implemented such that a “hot” sound can increase when an active region is near a pointer, etc. These visual or audio enhancement techniques may be implemented using technologies known in the art and need not be described in more detail herein.

3. Dynamically Creating a Digital Active Image

In an exemplary implementation, active images may be created in substantially real time, for example, during a meeting. In this example, a digital image, of the participants at a meeting, is taken during the meeting (e.g., via digital camera 130). The digital image may also show one or more pieces of shared objects, such as electronic equipment (e.g., computer, projector, electronic white board, etc.) and/or non-electronic objects (e.g., books, etc.), in the meeting room. The digital image may be displayed to the participants via a computer screen connected to a computer in the meeting room. In an exemplary implementation, materials (e.g., documents, slides, etc.) to be presented during the meeting are preloaded into the computer.

During the meeting, each participant may add annotations and/or links to the image. For example, a participant may add a link to his/her homepage by dragging and selecting a region around his/her head (or avatar or other representation of the user), and entering the desired URL of the link in the fields provided on the screen. A participant may also record a comment as a sound clip in real time and associate that comment to any region on the image.

As another example, a participant might dynamically link to the presentation material(s) being outputted on any of the electronic equipment in the meeting room. For example, if a projector is being used to display a document, a participant who wants to link the document being displayed to the image could drag and select the image of the projector. In an exemplary implementation, the server might be configured to monitor the file names and locations of all documents sent (or to be sent) to the projector. For example, a menu displaying the file names and locations of all materials preloaded into the computer could appear on the screen when the image of the projector is selected. In this implementation, the participant would then select the file name and location of the document he/she wishes to link to the image of the projector.

In yet another exemplary implementation, a menu displaying a list of electronic equipment, and materials associated with each equipment, are displayed in a menu. In this implementation, a participant can first drag and select any region on the image, then select an output device, then select the materials associated with that output device to be linked to the active region.

Subsequent to the live session, the active image of the meeting can be accessed (e.g., via the Internet) and further augmented by anyone having permission to do so.

B. Creating a Non-Digital Active Image

Active regions may also be created on a non-digital base image (e.g., a printed image, or any other form of image fixed in a tangible medium) to make the image active.

In an exemplary implementation, a transparent overlay may be placed over a printed image. The overlay is entirely optional, but is useful in cases where it is desired to protect the image. The overlay should include a mechanism for proper two-dimensional registration with the image. Such registration mechanism could include lining up opposite corners of the image and the overlay (if they are the same size), matching targets (e.g. cross-hairs or image features) on the image and overlay, etc.

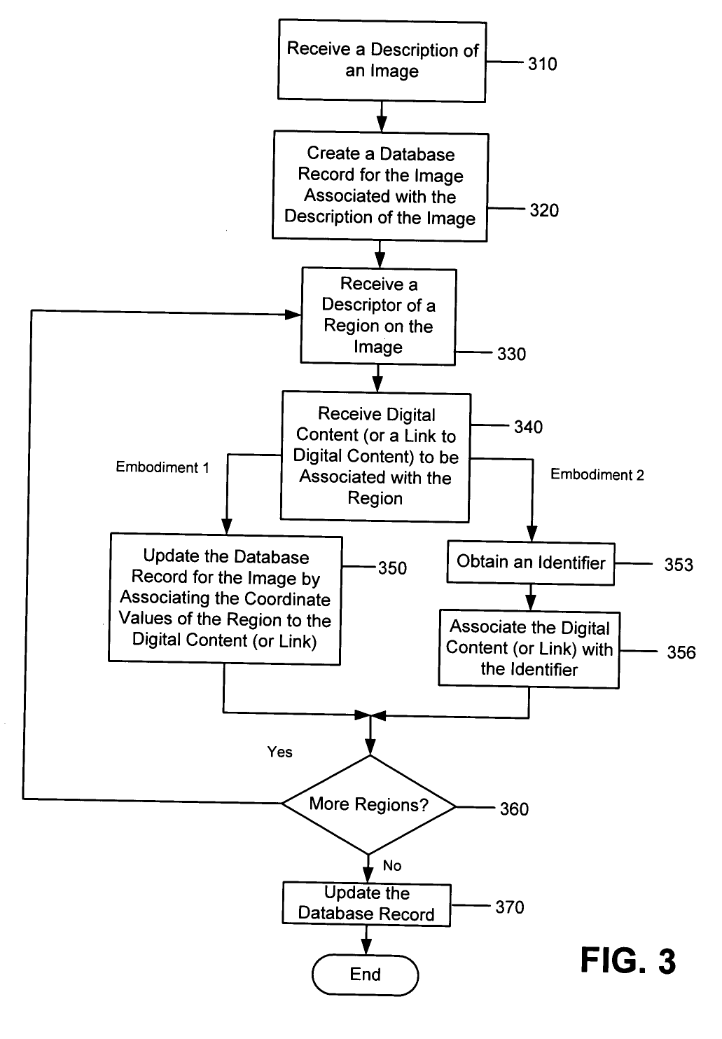

FIG. 3 illustrates an exemplary process for creating a non-digital active image. At step 310, the server 140 receives from the user a description of a base image. At step 320, this information is used to create a database record for the image.

At step 330, the server receives a descriptor (e.g., the user's selection) of a region, on the image, to be linked to digital content. In a first embodiment, prior to user selection, the printed image (optionally protected by the transparent overlay) will have been placed on an electronic tray (or clipboard, tablet, easel, slate, or other form of document holder) that is capable of determining coordinate values of any region within or around the printed image. Technologies for determining coordinate values within or around a printed image are known and need not be described in more detail herein. For example, the user's selection can be effected using RF/ultrasound technology to track the location of a pen (or other form of stylus or pointing device) as the user moves the pen across the image. This type of technology is currently commercially available, for example, the Seiko's Inklink handwriting capture system may be adapted for creating user-specified active regions in non-digital active images.

In an exemplary implementation, the image tray 110 includes an RF/ultrasound-enabled receiver for sensing the coordinate locations of a smart pen, which in turn includes a transmitter, in relation to the receiver. The tray 110 is connected (via wire or wirelessly) to server 140 (e.g., via the computer 100) to process the received signals. In this implementation, the printed image may be placed on the tray 110 having the receiver at the top of the tray and a pen which may be used to select different regions on the printed image by tracing the boundary of the desired active region (e.g., clicking on each of the vertices of a user-specified polygon approximately bounding the active region of interest) on the printed image. The coordinate values defining the active region being specified are transmitted from the pen to the receiver, then to the server 140 via the computer 100. This technology allows both physical (written) and digital annotations and the pen's position may be tracked with minimal pressure against the surface of the printed image.

Corresponding to each active region so specified, fields may be displayed via computer 100 for entering digital content (e.g., one or more files, links to files, and perhaps also any desired annotations) to be associated with the specified region on the printed image. In another implementation, a user can navigate to digital content to be associated with the specified region using a browser application on the computer 100 and the address to the digital content can be automatically linked to the specified region by the server 140. At step 340, the server 140 receives (either locally or remotely, as applicable) a representation of digital content to be associated with the selected region. Any entered annotations (text or sound) and/or links are then associated with the specified active region in the database record.

In this embodiment, as shown at step 350, the selected region is identified by its coordinates, and the server 140 updates the database record for the image by associating the coordinate values of the selected region with the digital content (or a link thereto). At step 360, the process is repeated for additional user-specified regions (if any), and at step 370, the database record for the image is updated accordingly.

The exemplary tray technology is merely illustrative. One skilled in the art will recognize that still other coordinate identification technologies may be implemented in accordance with design choice. For example, a pressure-sensitive tablet may be used where the coordinate values of a selected region may be calculated based on the areas being pressed by a user. More generally, any form of digitizing tablet allowing tracking of user-specified regions can be used to define the active regions.

After having electronically specified the active regions to be associated with the image, and having created the computer file(s) necessary to capture the association of remote digital content with those active regions, it is useful to physically mark those active regions on the image for users' future reference. That is, a user looking at the printed image should be given some indication that it is, in fact, an active image rather than an ordinary printed image. In one embodiment, the marking can be implemented using any appropriate visual or audio enhancement technique. Further, the visual enhancements may be implemented directly on the printed image, or on a transparent overlay (e.g., to protect the printed image). Many such visual enhancement techniques provide a qualitative (e.g., change in color, shading, etc.), rather than a quantitative, indicator of the presence of an active region. The audio enhancements may be implemented by digitally generating sound indicators when near or approaching an active region. For example, a “hot-cold” sound may be implemented where the “hot” sound gets louder as the stylus nears an active region.

In a second exemplary implementation, active regions may be marked using unique quantitative identifiers (e.g., bar codes, etc.) affixed on the printed image (or on the transparent overlay) using the techniques described in the Related Application. Since the identifiers provide unique quantitative information, they can even be used as a substitute for, or supplement to, coordinate-based descriptions of the active region. This is depicted schematically by steps 353 and 356 of FIG. 3. At step 353, the identifier is provided to server 140, and at step 356, the digital content (or link thereto) is associated with the identifier—which, in turn, uniquely identifies its corresponding active region.

IV. Accessing Active Regions of an Active Image

Exemplary processes for accessing both digital and non-digital active images are described in more detail below.

A. Accessing Active Regions on a Digital Active Image

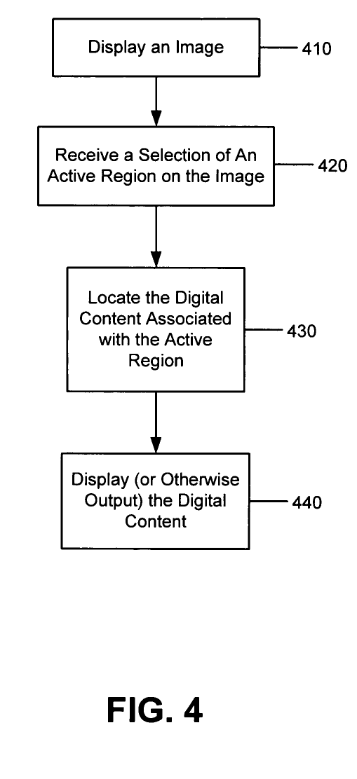

A digital active image may be accessed via a computer having access to servers storing the active images (e.g., via the Internet). FIG. 4 illustrates an exemplary process for accessing a digital active image.

At step 410, a Web page containing one or more active images is provided to a user.

At step 420, the user selection of an active region on the displayed active image is received.

At step 430, the digital content (e.g., links and/or annotations) associated with the selected active region is located.

At step 440, based on the user selection, the digital content associated with the selected region are obtained and outputted to the user.

B. Accessing Active Regions on a Non-Digital Active Image

The active regions within a non-digital active image may be accessed using techniques appropriate to the ways in which the active regions were marked.

The markings might be simple visual or audio enhancements (e.g., colors, shading, “hot-cold” sounds, etc.) that identify the active region but are not directly usable to go to the digital content that is associated (via a remote computer file or database) with that active region. In that case, access can be provided using the techniques described in Section IV.B.1 below. Alternatively, the markings might be unique identifiers that are actually usable to take the user to the digital content linked to that active region. In that case, access can be provided using the techniques described in Section IV.B.2 below.

1. Accessing Active Regions via Visual or Audio Enhancement Indicators

In one exemplary implementation corresponding to the first embodiment (see step 350) of FIG. 3, the active regions on a printed active image are characterized by their coordinate values. Thus, the corresponding associated digital content (if any) for any user-specified location on the image may be located once the location's coordinates are known. These coordinates may be determined in a similar manner as described in Section III.B above.

For example, the printed image (and/or, if applicable, a transparent overlay) having visual enhancement indicators is placed on a tray implementing RF/ultrasound technology. In an exemplary implementation, an identifier (e.g., on the back of the printed image) may be manually read (e.g., via a scanner 120) or automatically read (e.g., via the image tray 110) to identify the printed image. Using a pen capable of transmitting coordinate values to a receiver connected to a computer, a user can point to areas on the transparent overlay having visual enhancement indicators. When the computer receives the coordinate values of a region on the printed image, the computer resolves the coordinate value to obtain its associated annotation and/or link. Such associated annotation and/or link is outputted to the user via an output device controlled by the computer (e.g., a computer monitor, a stereo, etc.). This example is merely illustrative. Other enhancement indicators may be implemented according to design choice. For example, an audio indicator, such as a “hot-cold” sound indicator, may be implemented. In this example, the “hot” sound may get louder when the stylus (e.g., pen) gets closer to an active region on the printed image.

2. Accessing Active Regions via Identifiers

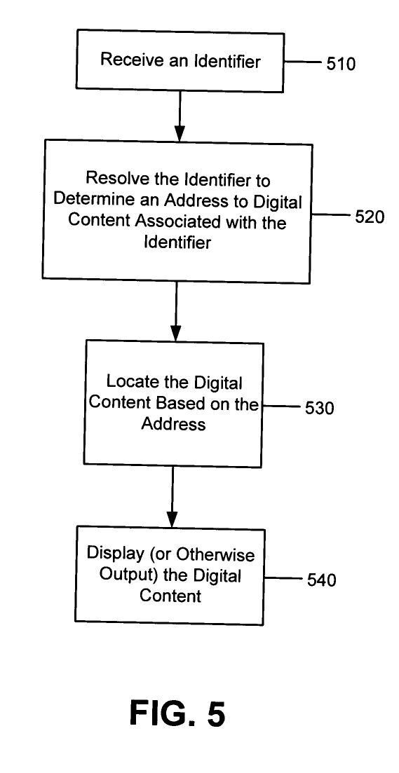

In another exemplary implementation, corresponding to the second embodiment (see steps 353 & 356) of FIG. 3, the active image may be identified by a unique identifier (e.g., a bar code) affixed to the printed active image or on a transparent overlay on top of the printed active image. FIG. 5 illustrates an exemplary process for accessing active regions within an active image using identifiers. At step 510, the server 140 receives a user-inputted identifier. This may be effected by typing in an alphanumeric identifier, or by reading a machine-readable identifier using well-known, commercially available scanner technology (e.g., a bar code scanner). In this exemplary implementation, the identifier is assumed to be globally unique. In an alternative embodiment, the use of contextually unique identifiers will be discussed in Section V below.

At step 520, the identifier is transferred to server 140 (in real time or subsequently via a reader docking station) which can resolve the identifier locally or remotely. For example, if the identifier has been previously associated with an annotation or a link to a Web resource or a file in a local hard drive, the result of the resolution might be an address for the digital content. The content is then located, at step 530, and displayed (or otherwise outputted) at step 540. For more details of the use of identifiers for linking, please refer to the Related Application, which is incorporated by reference in its entirety.

3. Other Technologies

The techniques disclosed herein are merely exemplary. Other technologies may also be implemented depending on design choice.

### V. Using Contextual Identifiers to Identify Active Regions on an Active Image

As described in various exemplary embodiments above, globally unique identifiers (e.g., bar codes, RF ID tags, glyphs, etc.) can be used to identify digital content to be linked to active regions on a base image. Such identifiers would be placed on their respective active regions (either directly, or indirectly via an overlay). For example, each item of digital content can be identified by a unique bar code printed on a clear sticker (or other form of physical token). Sometimes limited space on the sticker (or on the base image) may favor smaller identifiers. At the same time, the identifiers must remain unique to avoid ambiguity.

Uniqueness, however, can be global, or contextual. Thus, it is possible to maintain uniqueness using contextual identifiers that are not globally unique, as long as the environment in which they are used is globally unique (and so identifiable). Thus, contextual identifiers may be made smaller relative to the length of globally unique identifiers.

In an exemplary implementation of contextual identifiers, a particular tangible medium representing a base image is identified by a globally unique identifier, while individual active regions within the base image are identified by contextual identifiers. The contextual identifier might even be as simple as a single-character (e.g., 0, 1, 2, etc.). The contextual identifier need only uniquely identify any item of content in the base image, which in turn is uniquely identified by the globally unique identifier.

A. An Exemplary Process for Associating Contextual Identifiers with an Active Region

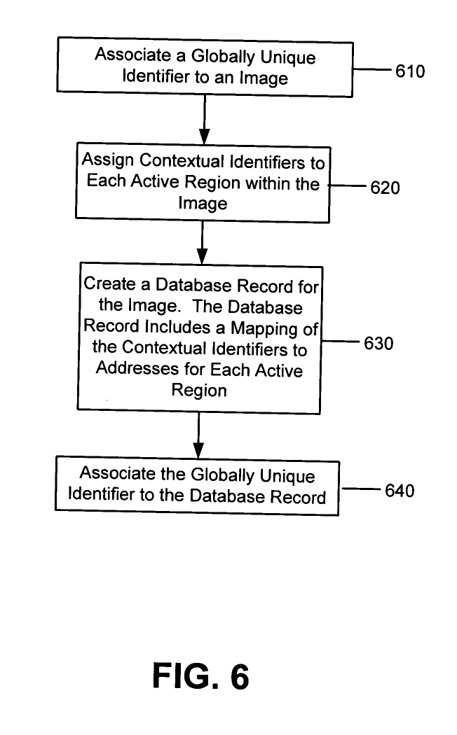

FIG. 6 illustrates an exemplary process for associating contextual identifiers with digital content linked to active regions.

At step 610, a globally unique identifier (e.g., a unique bar code, etc.) is associated with a tangible medium containing a non-digital base image. In an exemplary implementation, the globally unique identifier is physically affixed to, or otherwise printed on, the tangible medium (or perhaps to an overlay therefor).

The globally unique identifier is digitally associated with the tangible medium by creating a database record (e.g., by the server 140) to associate the identifier with a description of the tangible medium (e.g., a Photograph of Grandma). Globally unique identifiers can be generated using technologies known in the art and need not be described in more detail herein. As an example of one such technology, see “The ‘tag’ URI Scheme and URN Namespace,” Kindberg, T., and Hawke, S., at http://www.ietf.org/internet-drafts/draft-kindberg-tag-uri-04.txt. Many other examples are also known in the art and need not be referenced or described herein.

At step 620, contextual identifiers are assigned to each user-specified active region in the base image. In an exemplary implementation, the contextual identifiers may be alphanumeric characters (or bar codes representing alphanumeric characters) assigned to different active regions. These contextual identifiers can be printed on or otherwise affixed to the tangible medium. In an exemplary implementation, the contextual identifiers may be printed or otherwise affixed to the margins of the base image, with connecting lines to the designated regions, to avoid obscuring the image.

At step 630, a database record is created for the tangible medium to provide a mapping of the contextual identifiers to corresponding addresses associated with each active region in the collection.

At step 640, the globally unique identifier is associated with the database record so that the database record may be accessed when the globally unique identifier is read (e.g., by a bar code scanner). For example, when a globally unique identifier associated with a tangible medium is read, the corresponding database record created for that tangible medium is located. Subsequently, when a contextual identifier on the tangible medium is read, the database record is accessed to look up the address of the digital content associated with the contextual identifier.

The foregoing exemplary process for generating contextual identifiers for identifying active regions is merely illustrative. One skilled in the art will recognize that other processes or sequence of steps may be implemented to derive contextual identifiers in connection with a globally unique identifier.

B. An Exemplary Process for Accessing an Active Region Identified by a Contextual Identifier

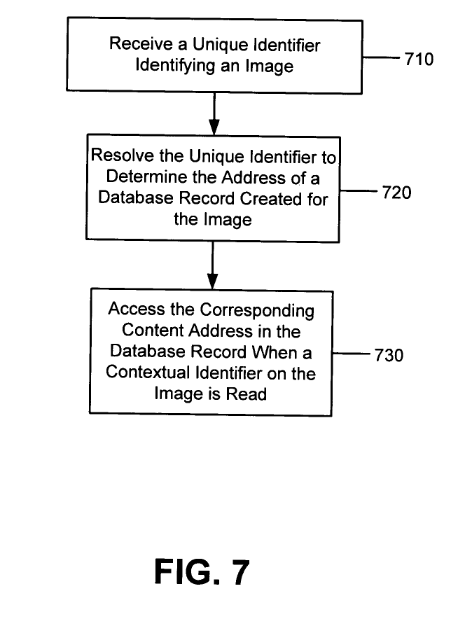

FIG. 7 illustrates an exemplary process for accessing digital content identified by contextual identifiers.

At step 710, a globally unique identifier identifying an image fixed on a tangible medium (e.g., a piece of printed paper) is read (e.g., by a portable bar code scanner, etc.). The globally unique identifier is provided to the server 140 via the network 160.

At step 720, the identifier is resolved by the server 140 by looking up the address of a database record previously generated for the tangible medium (see step 630 above). Technologies for resolving identifiers are known in the art and need not be described in more detail herein. As an example of one such technology, see “Implementing physical hyperlinks using ubiquitous identifier resolution”, T. Kindberg, 11th International World Wide Web Conference, at http://www2002.org/CDROM/refereed/485/index.html. Many other examples are also known in the art and need not be referenced or described herein. In an exemplary implementation, the database record contains a mapping of contextual identifiers on the tangible medium to addresses of corresponding digital content associated with the contextual identifiers.

At step 730, each time a contextual identifier on the tangible medium is read, the appropriate content is obtained from the corresponding address in the database record.

C. Other Applications of Contextual Identifiers

Some linked digital content, such as a Web page or an image, may further include links to other digital content. In one embodiment, globally unique identifiers may be implemented to enable access to the Web page, and contextual identifiers may be associated with the links on the printed Web page by implementing the process described above in FIG. 6.

Many variations are possible. For example, if the links themselves represent Web pages having additional links, the hierarchy of links could be represented using a hierarchy of contextual identifiers. Or, if a link represents a Web page outside the current domain (e.g., having a different globally unique identifier), that link could be represented by a corresponding globally unique identifier (either per se or in connection with its own associated contextual identifiers).

### VI. Conclusion

The foregoing examples illustrate certain exemplary embodiments from which other embodiments, variations, and modifications will be apparent to those skilled in the art. The inventions should therefore not be limited to the particular embodiments discussed above, but rather are defined by the claims. Furthermore, some of the claims may include alphanumeric identifiers to distinguish the elements thereof. Such identifiers are merely provided for convenience in reading, and should not necessarily be construed as requiring or implying a particular order of steps, or a particular sequential relationship among the claim elements.

1. A method for creating a non-digital active image, fixed in a tangible medium, at least one region of which may be selected by a user to access digital content on an electronic output device, comprising:
obtaining a description of a base image, said base image including non-digital content fixed in a tangible medium;
creating a database record for said base image associated with said description;
receiving a descriptor of a region of said base image;
receiving a representation of digital content; and
associating said descriptor with said digital content in said database record, thereby creating an active image usable to electronically access said digital content from said base image of non-digital content fixed in said tangible medium.

2. The method of claim 1, wherein said tangible medium includes paper.

3. The method of claim 1, wherein said representation of digital content includes a file containing said digital content.

4. The method of claim 1, wherein said representation of digital content includes a network link to said digital content.

5. The method of claim 1, wherein said descriptor of said region includes a coordinate-based description of said region.

6. The method of claim 5, wherein said descriptor of said region is received from an electronic tray onto which said tangible medium was placed, said electronic tray being configured to determine a coordinate value of said region.

7. The method of claim 1, wherein said descriptor of said region includes an identifier of said region.

8. The method of claim 7, wherein said identifier is globally unique.

9. The method of claim 7, wherein said identifier includes a globally unique identifier for said tangible medium, and a contextually unique identifier for said region.

10. The method of claim 7, wherein said identifier includes a machine-readable indicia.

11. The method of claim 1, further comprising visually marking said region.

12. The method of claim 11, wherein said marking is performed on said tangible medium.

13. The method of claim 11, wherein said marking occurs on an overlay on said tangible medium.

14. The method of claim 1, further comprising indicating said region by an audio indicator.

15. A method for electronically outputting digital content accessed by selecting regions of a non-digital active image fixed in a tangible medium, comprising:
receiving a descriptor of a region of an image, said image including:
(i) non-digital content fixed in a tangible medium; and
(ii) at least one predetermined region, of said image, that is associated with digital content via a database record in a computer system;
obtaining said database record;
resolving said descriptor to determine digital content associated therewith in said database record; and
electronically obtaining and outputting, to said user, said determined digital content.

16. The method of claim 15, wherein said tangible medium includes paper.

17. The method of claim 17, wherein said descriptor of said region includes a coordinate-based description of said region.

18. The method of claim 15, wherein said descriptor of said region is received from an electronic tray onto which said tangible medium was placed, said electronic tray being configured to determine a coordinate value of said region.

19. The method of claim 15, wherein said descriptor of said region includes an identifier of said region.

20. The method of claim 19, wherein said identifier is globally unique.

21. The method of claim 19, wherein said identifier includes a globally unique identifier for said tangible medium, and a contextually unique identifier for said region.

22. The method of claim 19, wherein said identifier includes a machine-readable indicia.

23. The method of claim 15, wherein receiving said descriptor is performed with the aid of an overlay on said tangible medium.

24. A computer-readable medium comprising logic instructions for creating a non-digital active image, fixed in a tangible medium, at least one region of which that may be selected by a user to access digital content on an electronic output device, said logic instructions being executable to:
obtain a description of a base image, said base image including non-digital content fixed in a tangible medium;
create an electronic record for said base image associated with said description;
receive a descriptor of a region of said base image;
receive a representation of digital content; and
associate said descriptor with said digital content in said record;
thereby creating an active image usable to electronically access said digital content from said base image of non-digital content fixed in said tangible medium.

25. The computer-readable medium of claim 24, wherein said tangible medium includes paper.

26. The computer-readable medium of claim 24, wherein said descriptor of said region includes a coordinate-based description of said region.

27. The computer-readable medium of claim 24, wherein said descriptor of said region includes a machine-readable indicia.

28. A computer-readable medium comprising logic instructions for electronically outputting digital content accessed by selecting regions of a non-digital active image fixed in a tangible medium, said logic instructions being executable to:
receive a descriptor of a region of an image, said image including:
(i) non-digital content fixed in a tangible medium; and
(ii) at least one predetermined region, of said image, that is associated with digital content via a record in a computer system;
obtain said record;
resolve said descriptor to determine digital content associated therewith in said record; and
electronically obtain and output, to said user, said determined digital content.

29. The computer-readable medium of claim 28, wherein said tangible medium includes paper.

30. The computer-readable medium of claim 28, wherein said descriptor of said region includes a coordinate-based description of said region.

31. The computer-readable medium of claim 28, wherein said identifier includes a machine-readable indicia.

32. Apparatus for creating a non-digital active image, fixed in a tangible medium, at least one region of which may be selected by a user to access digital content on an electronic output device, comprising:
means for obtaining a reference to a base image, said base image including non-digital content fixed in a tangible medium;
means for creating an electronic record for said base image, said electronic record being associated with said reference;
means for receiving a descriptor of a region of said base image;
means for receiving a representation of digital content; and
means for associating said descriptor with said digital content in said record;
thereby creating an active image usable to electronically access said digital content from said base image of non-digital content fixed in said tangible medium.

33. Apparatus for electronically outputting digital content accessed by selecting regions of a non-digital active image fixed in a tangible medium, comprising:
means for receiving a descriptor of a region of an image, said image including:
(i) non-digital content fixed in a tangible medium; and
(ii) at least one predetermined region, of said image, that is associated with digital content via a record in a computer system;
means for obtaining said record;
means for resolving said descriptor to determine digital content associated therewith in said record; and
means for electronically obtaining and outputting, to said user, said determined digital content.

34. A method for creating an active image in a collaborative environment, at least one region of said active image may be selected by a user to access digital content on an electronic output device, comprising:
obtaining a reference to a base image, said base image including images of participants and at least one shared object being used in a collaborative environment;
receiving a participant-specified descriptor of a region of said base image;
receiving a participant-specified representation of digital content, said digital content including:
(i) an electronic copy of materials being presented in said collaborative environment via said at least one shared object;
associating said descriptor with said digital content; and
updating said base image including the association between said descriptor and said digital content, thereby creating an active image usable to electronically access said digital content from said base image.

35. The method of claim 34, wherein said participant-specified representation of digital content includes a file containing said digital content.

36. The method of claim 34, wherein said participant-specified representation of digital content includes a network link to said digital content.

37. The method of claim 34, further comprising displaying a menu on a computer screen in said collaborative environment, said menu including:
(i) a list of electronic equipment used in said collaborative environment; and
(ii) a list of file names and locations of materials to be displayed by said electronic equipment in said collaborative environment.

38. The method of claim 37, wherein said participant-specified representation is determined by a participant selection of an electronic equipment in said list of electronic equipment and a participant selection of a file name and location in said list of materials.

39. A computer-readable medium comprising logic instructions for electronically creating an active image in a collaborative environment, at least one region of said active image may be selected by a user to access digital content on an electronic output device, said logic instructions being executable to:
obtain a reference to a base image, said base image including images of participants and at least one shared object being used in a collaborative environment;
receive a participant-specified descriptor of a region of said base image;
receive a participant-specified representation of digital content, said digital content including:
(i) an electronic copy of materials being presented in said collaborative environment via said at least one shared object;
associate said descriptor with said digital content; and
update said base image including the association between said descriptor and said digital content, thereby creating an active image usable to electronically access said digital content from said base image.

40. The computer-readable medium of claim 39, wherein said representation of digital content includes a file containing said digital content.

41. The computer-readable medium of claim 39, wherein said participant-specified representation of digital content includes a network link to said digital content.

42. The computer-readable medium of claim 39, further comprising logic instructions being executable to display a menu on a computer screen in said collaborative environment, said menu including a list of electronic equipment used in said collaborative environment and a list of file names and locations of materials to be displayed by said electronic equipment in said collaborative environment.

43. The computer-readable medium of claim 42, wherein said participant-specified representation is determined by a participant selection of an electronic equipment in said list of electronic equipment and a participant selection of a file name and location in said list of materials.

44. Apparatus for creating an active image in a collaborative environment, at least one region of said active image may be selected by a user to access digital content on an electronic output device, comprising:
means for obtaining a reference to a base image, said base image including images of participants and at least one shared object being used in a collaborative environment;
means for receiving a participant-specified descriptor of a region of said base image;
means for receiving a participant-specified representation of digital content, said digital content including:
(i) an electronic copy of materials being presented in said collaborative environment via said at least one shared object;
means for associating said descriptor with said digital content; and
means for updating said base image including the association between said descriptor and said digital content, thereby creating an active image usable to electronically access said digital content from said base image.
